(19) United States
(12) Patent Application Publication
(10) Pub. No.: US 2005/0231643 A1
(43) Pub. Date: Oct. 20, 2005

(54) Method, system and device for real-time non-linear video transformations

(75) Inventors: David Allan Ross, Nepean (CA); Alun John Fryer, Ontario (CA); Troy David English, Ottawa (CA); Yu Liu, Ottawa (CA); Mike Boothroyd, Ottawa (CA)

Correspondence Address: NIXON PEABODY, LLP, 401 9TH STREET, NW, SUITE 900, WASHINGTON, DC, 20004-2128, US

(73) Assignee: Ross Video Limited, Iroquois (CA)

(21) Appl. No.: 11/087,503

(22) Filed: Mar. 24, 2005

Related U.S. Application Data
(60) Provisional application No. 60/556,506, filed on Mar. 26, 2004.

(51) Int. Cl. H04N 9/74

(52) U.S. Cl. 348/578

(57) ABSTRACT

A method, system, and device for video transformation, including generating arbitrary, non-linear video effects; generating the video effects in real-time or near real-time; providing software algorithms used to generate video transformations corresponding to the video effects; employing a microprocessor to generate an address map corresponding to the video effects; employing an interpolator to read the address map in real-time or near real-time; and manipulating via the interpolator video pixel data in real-time or near real-time to generate a desired output video image corresponding to one of the video effects.

### CROSS REFERENCE TO RELATED DOCUMENTS

The present invention claims benefit of priority to U.S. Provisional Patent Application Ser. No. 60/556,506 of ROSS et al., entitled “Method, System and Device for Real-Time Non-Linear Video Transformations,” filed Mar. 26, 2004, the entire disclosure of which is hereby incorporated by reference herein.

### BACKGROUND

1. Field of the Invention

The present invention relates in general to digital transformation of a video image, and more specifically a method, system and device for generating non-linear video transformations in real time.

2. Discussion of the Background

In the field of broadcasting and video production it is often desirable to add “special effects” to a production. These special effects can be as simple as a dissolve between two video images, or a complex transformation of one or more images. A certain class of effects is known in the field as Digital Video Effects (DVEs). This is a special class of effects in which elements of video are moved or transformed on the screen. Digital Video Effects (DVE) generators are devices that are used to create real-time, video transformations.

There are several classes of DVE. The simplest are two-dimensional (2D) and three-dimensional (3D) transformations. In these effects, an image is transformed linearly through two-dimensional manipulation (size and position in the horizontal and vertical axes), or three-dimensional manipulation (size, position, and rotation, in three axes with perspective) respectively. These effects are often referred to as planar effects, and are typically limited to manipulation of an image as a whole; thus multiple, independent transformations of an image requires additional DVE generators. FIG. 6 illustrates an example of a two-dimensional effect; FIG. 7 illustrates an example of a 3D planar effect.

A more advanced class of DVE involves the use of non-linear mapping of images. It can involve such effects as curved surfaces, multiple independent transformations within one DVE generator, or other arbitrarily shaped transforms. These non-linear effects are generally known in the field as Warp effects. FIG. 8 shows a typical Warp effect, where the video image is mapped onto a shape representing the page of a book turning. FIG. 9 is another example of a Warp effect, where the image is mapped onto the shape of a sphere.

The generation of planar effects involves the implementation of simple circuits to produce a linear rotation, translation, and scaling matrix. It is relatively simple using technology of today. U.S. Pat. No. 5,448,301 discloses a general design for planar effect. FIG. 10 shows a block diagram for a background art DVE device.

Current technologies for the generation of non-linear, or Warp effects, include specialized circuit elements and/or lookup-table memory elements for each type of effect to produce various mathematical transformation functions on the video image. Examples of these approaches are presented in U.S. Pat. No. 5,233,332 to Watanabe, et al. and U.S. Pat. No. 4,860,217 to Sasaki, et al.. By sequencing and combining these specialized elements, an implementation can generate a limited number of special effects. U.S. Pat. No. 6,069,668 adds more warp look-up tables to achieve various warp effects, such as particles and bursts. U.S. Pat. No. 6,069,668 also gives a brief survey in warp-based DVE design and categorizes into warp-driven systems those that use 2D warp means for the address generator shown in FIG. 10.

Other techniques to generate warp effects use a software-based approach. In this approach, software algorithms are used to create arbitrarily complex effects. These algorithms compute the transformations and manipulate the video. This computation is referred to as “rendering” and often is very time consuming because it uses thousands of polygons to construct arbitrarily shaped objects. It is not suitable for live broadcast applications, as these software algorithms are too slow to manipulate a video frame within that frame's allotted time interval, which is typically 16 to 20 ms. These techniques are generally used in post-production environments, where video images are assembled offline and recorded to videotape or disk for later real-time playback.

Although most of commercial DVE devices use warp-driven design due to their cost effectiveness, as mentioned in U.S. Pat. No. 6,069,668, these designs, however, still suffer from:

(i) Lack of flexibility: Each warp effect or a subset of warp effects may need particular circuits or lookup tables for a given implementation. New effects may need new hardware modules to be added for support.

(ii) Requirement of Huge external memory: Warp lookup tables are effective solutions for real-time implementation, but require a large size of physical storage (e.g., 2D implementations require lookup tables sized based on the horizontal resolution times the vertical resolution).

### SUMMARY OF THE INVENTION

Therefore, there is a need for a method, system, and device that addresses the above and other problems with conventional systems and methods. Advantageously, the exemplary embodiments provide a generic way to solve the above and other problems by employing a software-based solution, wherein low cost, high-speed microprocessors, such as DSP chips, and well-developed algorithms for warp effects can be employed, allowing software to implement warp effects in real time or near real time. Accordingly, in exemplary aspects of the present invention, a method, system, and device are provided for video transformation, including generating arbitrary, non-linear video effects; generating the video effects in real-time or near real-time; providing software algorithms used to generate video transformations corresponding to the video effects; employing a microprocessor to generate an address map corresponding to the video effects; employing an interpolator to read the address map in real-time or near real-time; and manipulating via the interpolator video pixel data in real-time or near real-time to generate a desired output video image corresponding to one of the video effects.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1E are used for illustrating exemplary embodiments of the present invention and operation thereof;

FIG. 2 illustrates an exemplary embodiment of the present invention, wherein multiple microprocessors are employed;

FIG. 3 illustrates an exemplary embodiment of the present invention, wherein lighting data is generated;

FIG. 4 illustrates an exemplary embodiment of the present invention, wherein transparency data is generated;

FIG. 5 illustrates an exemplary embodiment of microprocessor data flow of the present invention;

FIG. 6 is an example of a two-dimensional transformation effect;

FIG. 7 is an example of a three-dimensional planar transformation effect;

FIG. 8 is an example of a “Page Turn” Warp effect;

FIG. 9 is an example of a “Sphere” Warp effect; and

FIG. 10 is a block diagram of a background art Digital Video Effects (DVE) device.

### DETAILED DESCRIPTION OF THE PREFERRED EMBODIMENTS

A method, system, and device for real-time non-linear video transformations are described. In the following description, for purposes of explanation, numerous specific details are set forth in order to provide a thorough understanding of the present invention. It is apparent to one skilled in the art, however, that the present invention can be practiced without these specific details or with equivalent arrangements. In some instances, well-known structures and devices are shown in block diagram form in order to avoid unnecessarily obscuring the present invention.

The present invention includes recognition that current real-time Digital Video Effects (DVE) generators are limited to simple two-dimensional or three-dimensional transformations or a small number of non-linear “Warp” transformations. This is due to limitations in the hardware-centric implementation of the transform algorithms. More flexible, software-based methods are far too slow to be usable in a real-time manner. The exemplary embodiments of the invention employ a hybrid approach of software-based transformations with hardware pipelines for the video manipulation. The result allows flexible software-based transformations to be generated in real time.

Thus, the present invention describes a novel and generic method, system, and device to solve the problems posed in the prior art, and advances the state of the art by applying a software-based transformation generator to a real-time DVE generator.

In the DVE generator, transformations can be generated in one of two manners. In the first manner, for each pixel in the source video image, the transformation generator generates a co-ordinate of the desired position in the output video image. This is referred to as forward mapping and represented as:
\overline{P}_{tgr}=M\overline{E}_{src} (1)
where \overline{P}_{src} is a source pixel position vector, \overline{P}_{tgr} is a target or display pixel position vector, and M is a transformation matrix which is either spatial variant or invariant.

In the second manner, for each pixel in the output video image, the transformation generator generates a co-ordinate of the desired pixel in the source image. This is referred to as inverse mapping or reverse mapping and represented as:
\overline{P}_{src}=M⁻¹\overline{P}_{tgr} (2)
where M⁻¹ is inverse matrix of M.

Generally, M is factorized into several cascaded local transformation such that:
M=M₁M₂M₃ . . . Mⁿ or M⁻¹=Mₙ⁻¹ . . . M₃⁻¹M₂⁻¹M₁⁻¹ (3)

The exemplary embodiments employ a microprocessor to implement a part of cascaded transformations shown in formula 3. Advantageously, such devices can be cascaded or combined to form more complicated warp effects.

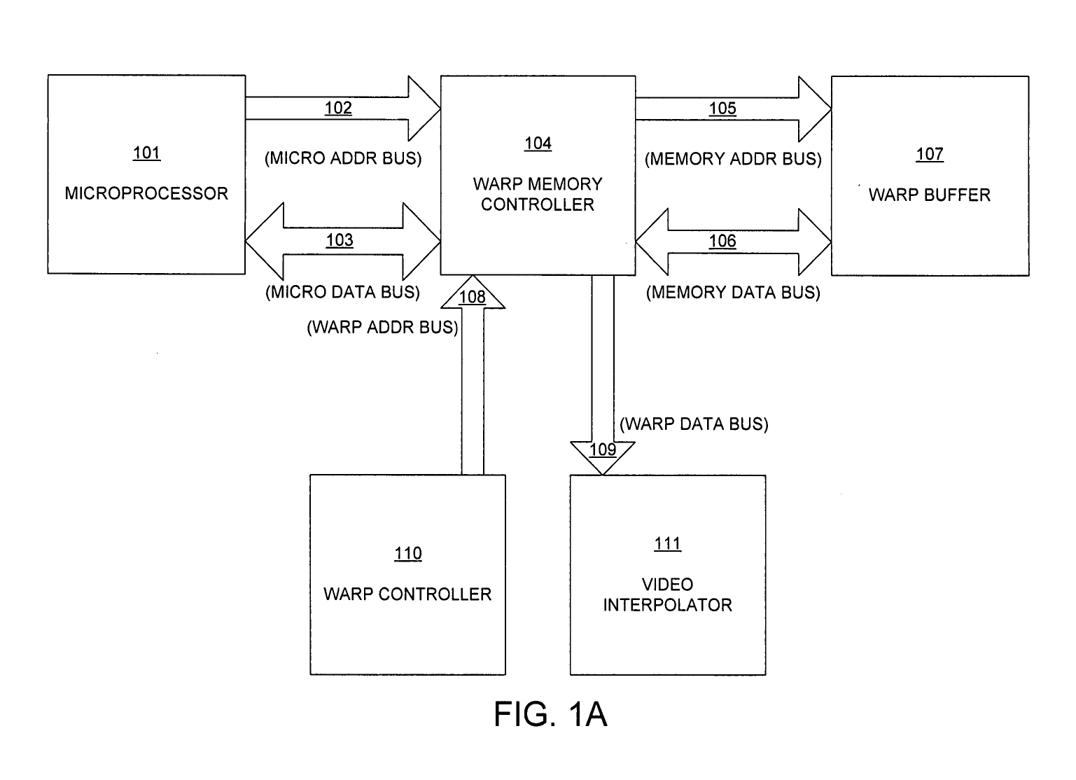

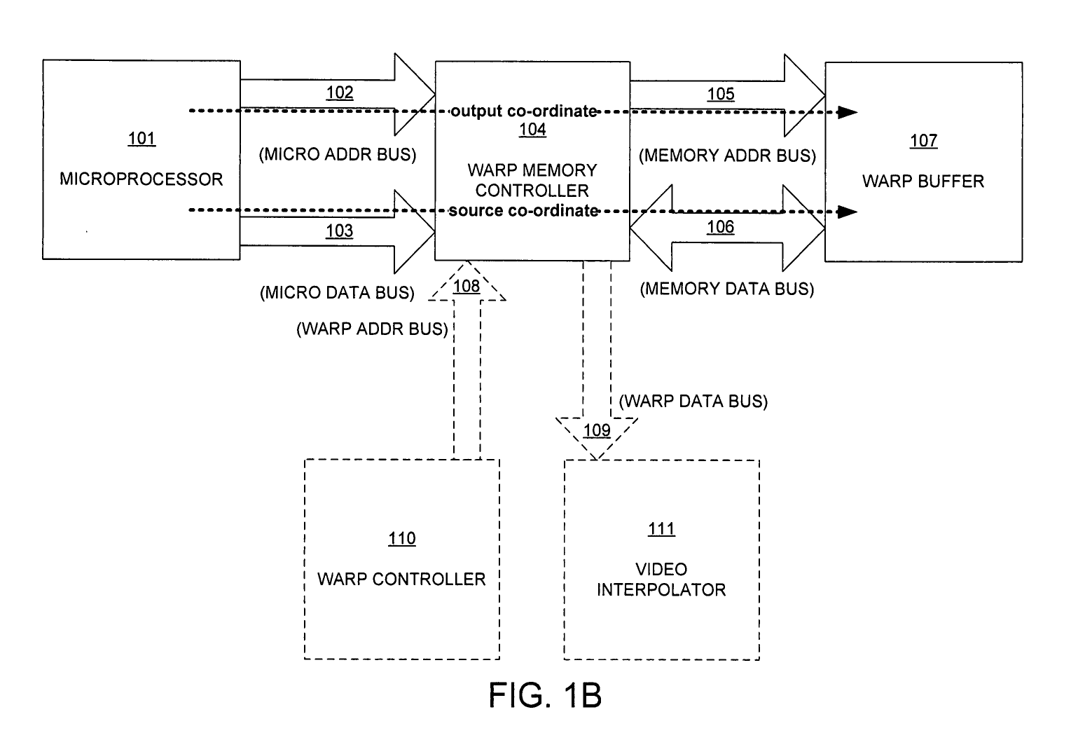

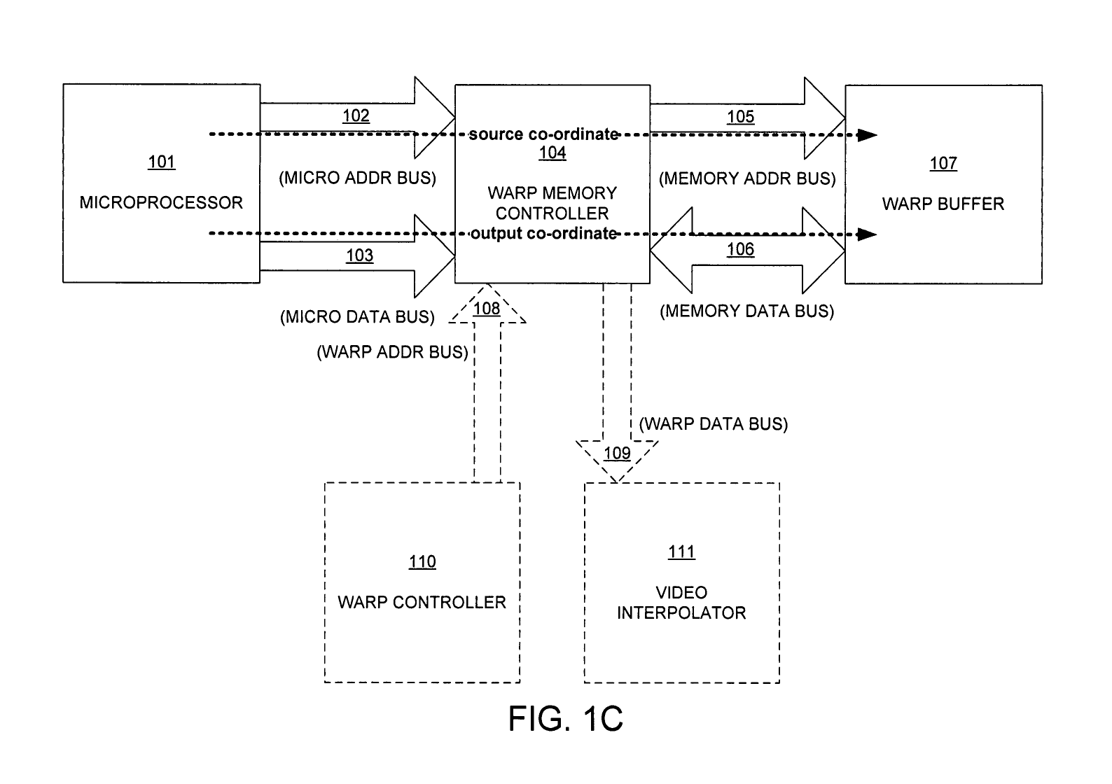

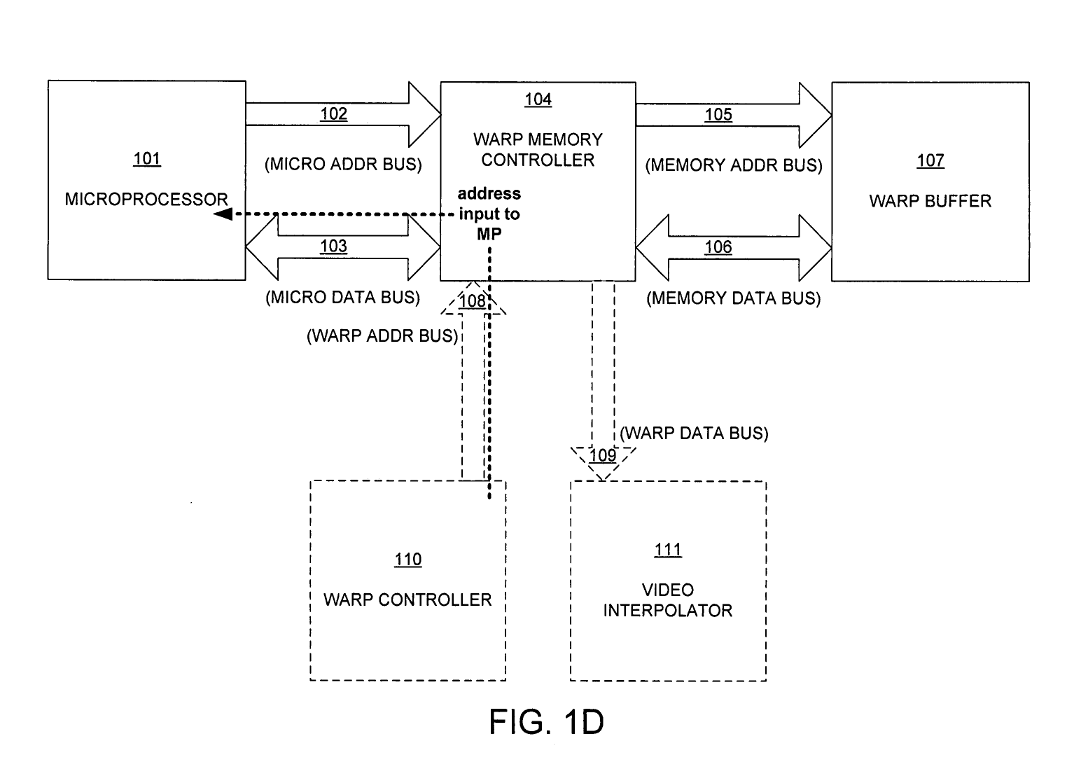

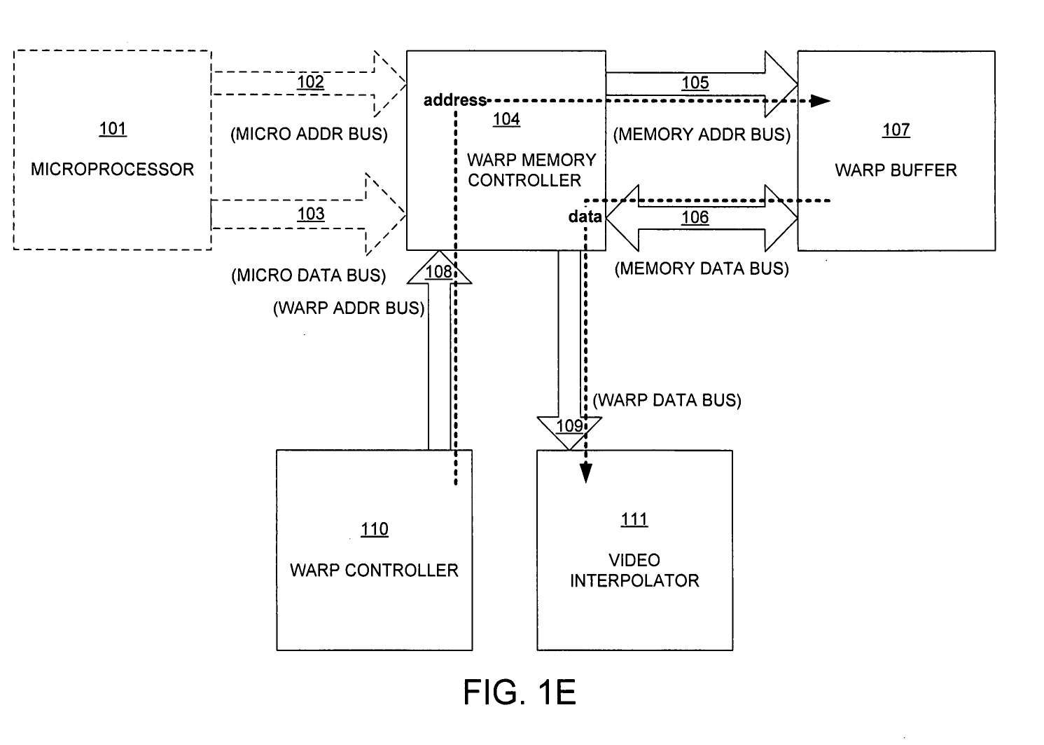

Referring to FIG. 1A, a microprocessor (101) employs software algorithms to produce transformation co-ordinates. The co-ordinates include an integer and fractional portion. This allows for sub-pixel accuracy in the transformation. The number of bits in each of the integer and fractional portions can vary by implementation, and can depend upon desired accuracy of sub-pixel position and overall image size.

The transformation co-ordinates can be either reverse mapping or forward mapping. In a forward-mapping system, illustrated in FIG. 1B, the microprocessor transfers to the Warp Memory Controller (104), the source image co-ordinate on the Microprocessor Address Bus (102) while providing the corresponding output image co-ordinate on the Microprocessor Data Bus (103). In a reverse-mapping system, illustrated in FIG. 1C, the microprocessor transfers to the Warp Memory Controller (104), the output image co-ordinate on the Microprocessor Address Bus (102) while providing the corresponding source image co-ordinate on the Microprocessor Data Bus (103). The implementation of the Microprocessor Address Bus (102) and Microprocessor Data Bus (103) is configured to ensure sufficient bandwidth such that the co-ordinates can be transferred at an average rate that is at least as fast as the video pixel clock rate.

The Warp Memory Controller (104) arbitrates memory accesses to the Warp Memory Buffer (107) between the Microprocessor (101) and the Warp Controller (110). Co-ordinate data received via the Microprocessor Address Bus (102) and the Microprocessor Data Bus (103) are written to the Warp Memory Buffer (107) via the Memory Address Bus (105) and the Memory Data Bus (106), as shown in FIGS. 1B and 1C. In an exemplary embodiment, sufficient bandwidth on the Memory Address Bus (105) and Memory Data Bus (106) to both write data received from the Microprocessor (101) and read data requested by the Warp Controller (110) are ensured.

The Warp Controller (110) provides a sequence of co-ordinates. In a forward mapping system, these co-ordinates are generated sequentially and represent the pixel position of the source video image. In a reverse-mapping system, these co-ordinates are generated sequentially and represent the pixel position of the output video image. In either system, these co-ordinates are passed to the Warp Memory Controller (104) via the Warp Address Bus (108). The implementation of this bus is configured to ensure sufficient bandwidth such that the co-ordinates can be transferred at an average rate which is at least as fast as the video pixel clock rate.

The Warp Memory Controller (104) reads from the Warp Memory Buffer (107) the co-ordinate data corresponding to the Warp Address requested on the Warp Address Bus (108). This address is passed to the Warp Memory Buffer (107) via the Memory Address Bus (105). Data is returned to the Warp Memory Controller (104) via the Memory Data Bus (106). This data is then passed onto the video interpolator (111), as shown in FIG. 1E.

Different from 2D warp lookup tables previously employed, Warp Memory Buffer (107) need not be a conventional lookup table. Rather, Warp Memory Buffer (107) can function as an elastic buffer, which converts non-constant generation rate of coordinate data from Microprocessor (101) into constant generation rate of coordinate data. Therefore, when a well-developed warp algorithm generates coordinate data at rate that doesn't fluctuate too much around the average pixel rate, the Warp Memory Buffer (107) does not require a large physical memory. In an exemplary embodiment, the Warp Memory Buffer need only store several lines or several tens of lines of coordinate data, because each of the warp algorithms need only finish the calculation of a horizontal line of coordinate data roughly in a horizontal line period. In addition, since Warp Memory Buffer (107) need not employ a large sized memory, advantageously, Warp Memory Buffer (107) can be realized by using internal memory in microprocessor or FPGA devices, and the like. In an exemplary embodiment, the microprocessor (101) reads the co-ordinates via Microprocessor Data Bus (103) and can use the co-ordinates to generate co-ordinate data that is later sent to Warp Memory Buffer (107), as shown in FIG. 1D.

In an exemplary embodiment, the Warp Controller (110) also can function as an interface to any other suitable address generators. In such an embodiment, the Warp Controller need not provide a sequence of co-ordinates, but rather passes input coordinates generated by such other address generators.

The Video Interpolator (111 ) is responsible for the actual manipulation of the video pixels. The methods employed by the Video Interpolator (111 ) can vary by implementation and can include over-sampling, filtering, and video memory access. In an exemplary embodiment, such methods are made independent of the other processes of the exemplary embodiments. By contrast, a software algorithm typically is used for both transform co-ordinate generation and video pixel manipulation. However, by limiting the scope of the software algorithms to generation of transform co-ordinates, advantageously, the exemplary software algorithms are within the capabilities of a variety of microprocessor devices.

Certain microprocessor devices, known as Digital Signal Processors (DSP), are very well suited to the generation of transformation co-ordinates, and the transfer of these co-ordinates at suitable speed to meet or exceed the average pixel rate of the video image, and which advantageously allows for a small sized Warp Memory Buffer (107).

If the complexity of effects increases to a point where the algorithms cannot generate transformation co-ordinates at a rate that is at least as fast as the average pixel rate of the video system, multiple microprocessors can be employed. Similarly, if faster video pixel rates are present, multiple processors can allow a faster average rate of transformation co-ordinate generation.

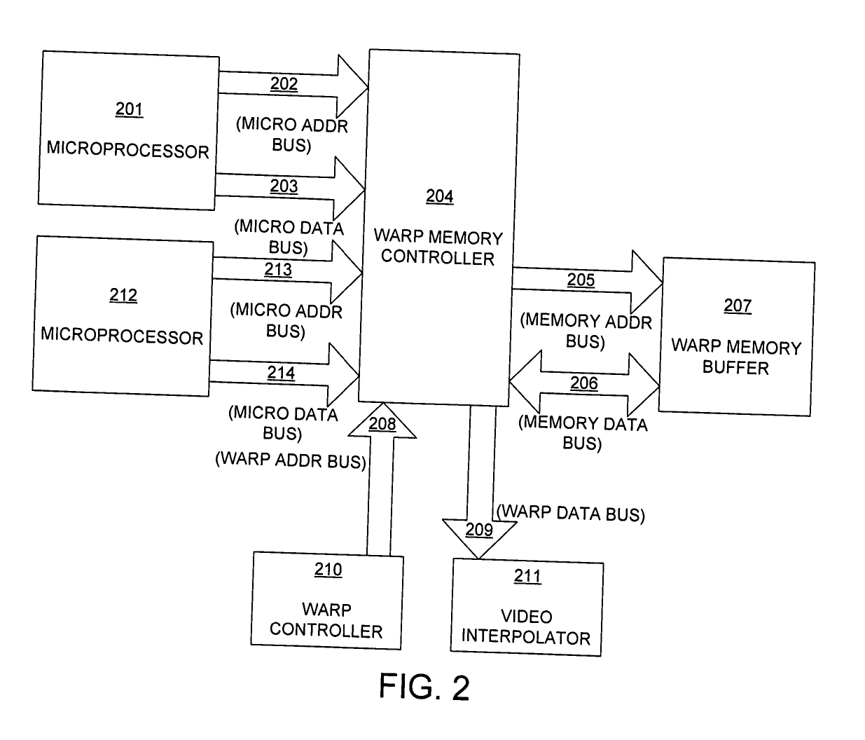

An example of this, using two microprocessors, is shown in FIG. 2. In this case, each microprocessor (201), (212), generates transformation co-ordinates for a separate field or frame of video data. Each processor need only generate the data for least one half the average video pixel rate, as each has two field or frame intervals to complete a transform for one field or frame. By obvious extension, three or more microprocessors can be employed to allow even greater average aggregate rates of transform co-ordinate generation.

Depending upon the bandwidth of the Microprocessor, Warp Memory Buffer and the various Address Buses and Data Buses, multiple sets of transformation co-ordinates can be generated within one frame or field. This can vary by implementation, but this method is scalable.

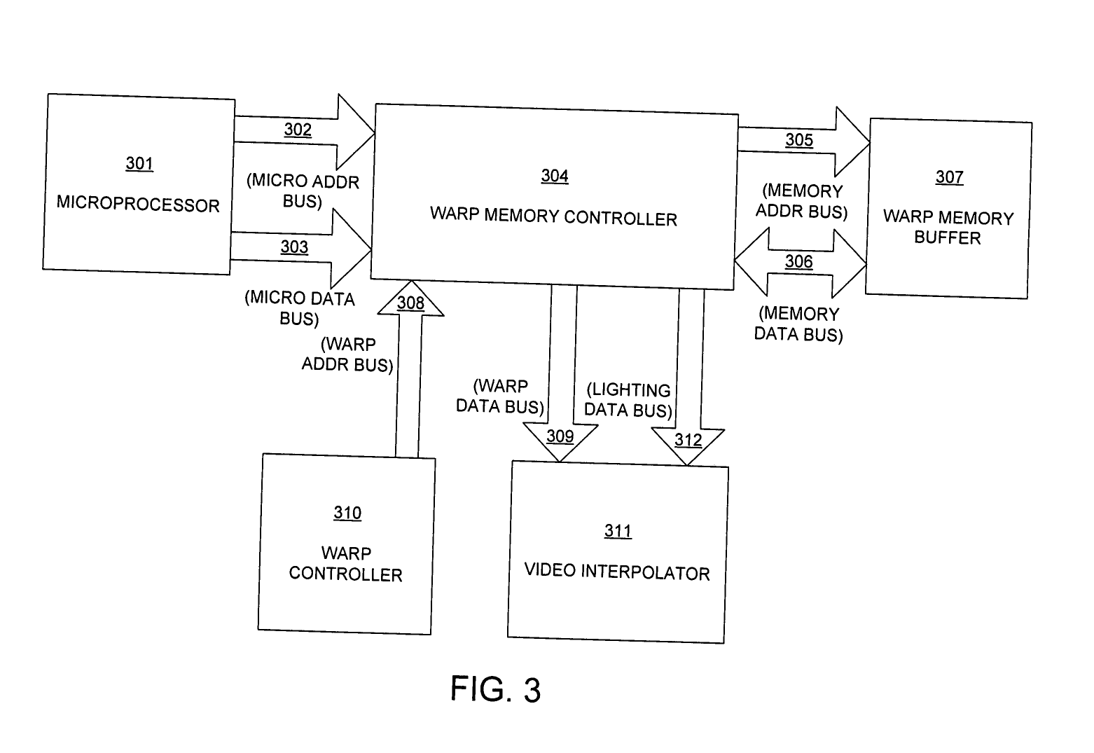

Video transformation effects can be greatly enhanced by the addition of lighting and shadows. These lighting and shadow elements can add greater depth and realism to the video effect. In a manner similar to the generation of the transformation co-ordinates, lighting and shadow components can be generated by the microprocessor. As shown in FIG. 3, the basic architecture is extended by the addition of a Lighting Data Bus (312). The microprocessor (301) generates a lighting map, which includes lighting and shadow data for each video pixel in the source image in the case of a forward-mapping system, or includes lighting and shadow data for each video pixel in the output video image in the case of a reverse-mapping system. This data is written to the Warp Memory Buffer (307) via the Warp Memory Controller, in the same manner as the transformation co-ordinate data.

As the Warp controller (310) provides co-ordinate data for the transform. The Warp Memory Controller (304) reads both transform data and lighting and shadow data from the Warp Memory Buffer (307) for the co-ordinates provided by the Warp Controller (310). The lighting data is passed to the Video Interpolator (311) via the Lighting Data Bus (312). The method for the application of the lighting and shadows to the video by the Video Interpolator can vary by implementation.

Further enhancement to the video transformation effect can be made by the addition of transparency data on a per-pixel basis. This is called an Alpha Map. The Alpha Map can be used to create semi-transparent effects for creative purposes or anti-aliasing through edge softening. Furthermore, if multiple transformation maps are being generated, these independent transforms can be layered upon each other with regions of transparency, semi-transparency, or opacity determined by the Alpha Map.

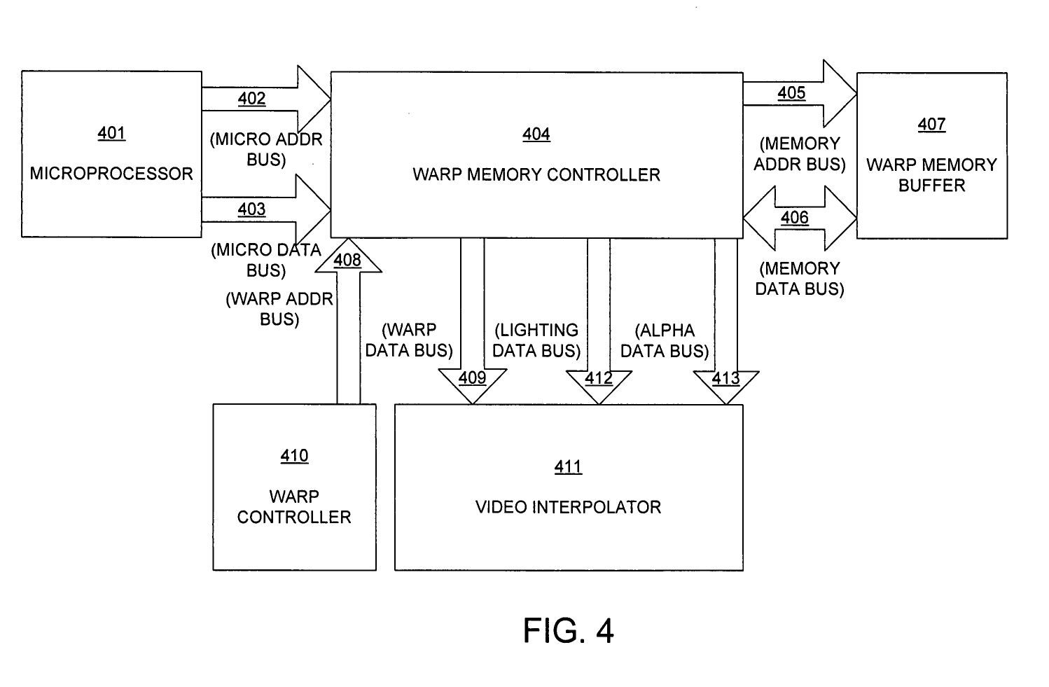

Referring to FIG. 4, the microprocessor (401) generates an Alpha map, which includes transparency data for each video pixel in the source image in the case of a forward-mapping system, or includes transparency data for each video pixel in the output video image in the case of a reverse-mapping system. This data is written to the Warp Memory Buffer (407) via the Warp Memory Controller, in the same manner as the transformation co-ordinate data.

As the Warp controller (410) provides co-ordinate data for the transform. The Warp Memory Controller (404) reads the transform data, lighting and shadow data, and the Transparency data from the Warp Memory Buffer (407) for the co-ordinates provided by the Warp Controller (410). The Transparency data is passed to the Video Interpolator (411) via the Alpha Data Bus (413). The method for the application of the Alpha Map and layering of the actual video pixels can vary by the implementation of the Video Interpolator (411). By extending the data width of Warp Memory Buffer (407), useful attributes similar to lighting data or alpha data for future warp effects implementations easily can be added.

In order to maximize the available bandwidth in the microprocessor (401), the Microprocessor Address Bus (402) and Microprocessor Data Bus (403), extensive use of a microprocessor's internal memory can be used. The use of internal memory frees the microprocessor's address and data bus for the purposes of transferring transformation co-ordinate data, lighting data, transparency data, and the like, to the Warp Memory Controller (404). Many microprocessors allow for the external bus to function independently of the internal bus through DMA allowing for data to be transferred to the external devices simultaneously with the microprocessor calculating it's warp and other data. Additionally, in many implementations, a microprocessor's internal memory provides a much faster access to program instructions and data than do external memory devices.

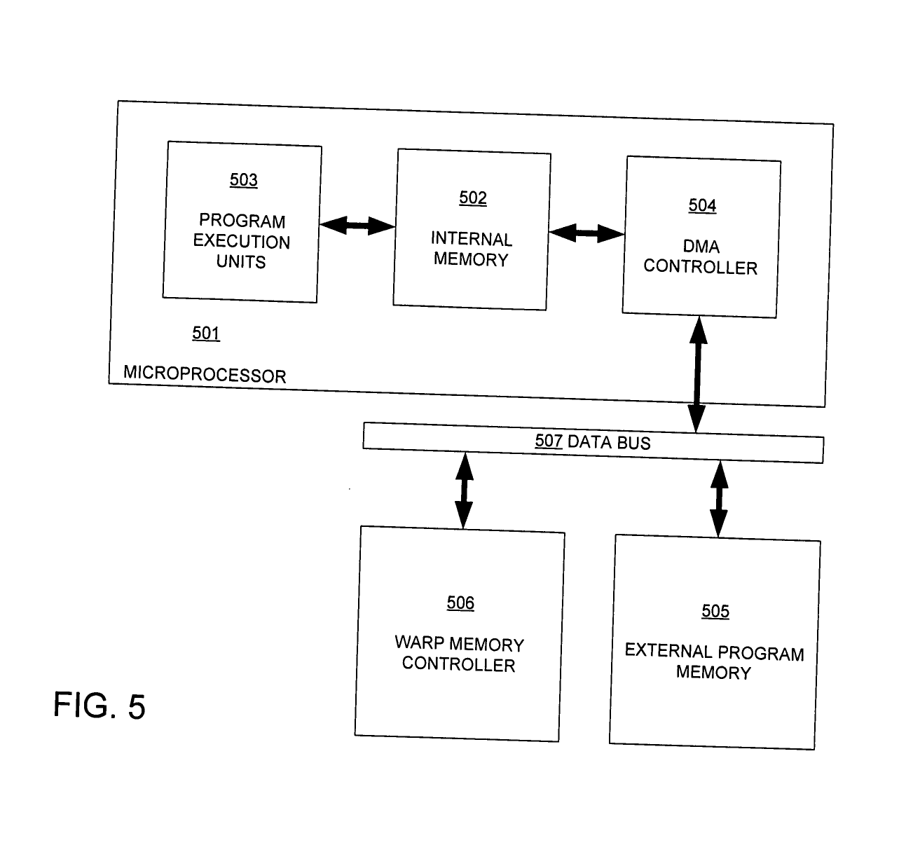

As detailed in FIG. 5, a microprocessor (501) including internal memory (502) is an exemplary method for implementation. Furthermore, this internal memory (502) can have a minimum capacity as to hold: (a) any software algorithm used in the implementation to generate transformation co-ordinates, (b) support, initialization, and intermediate data employed by the software algorithm, and (c) at least 2 complete horizontal scan lines worth of resultant transformation co-ordinates.

During the initialization of a software algorithm, the algorithm software is transferred from the external program memory (505), via the External Data bus (507) and DMA Controller to the Internal Memory (502). The Program Execution Units (503) are the means within the Microprocessor where the actual software algorithms are run. Software instructions are therefore fetched from the internal memory (502) and processed by the program Execution Units (503) according to the sequence in the software algorithm. Intermediate and output data (e.g., transformation co-ordinate data, lighting data, transparency data, and the like) from the algorithm can be written back to the internal memory (502). Once a pre-determined threshold quantity of such data have been written to the Internal Memory (502), the DMA controller (504) is instructed to begin the transfer of this data to the Warp Memory Controller (506) via the external data bus (507). Furthermore, the DMA Controller (504) can move data to the external data bus independently of the program execution, thereby eliminating the need for the software algorithm to wait for any external memory access or data bus activity.

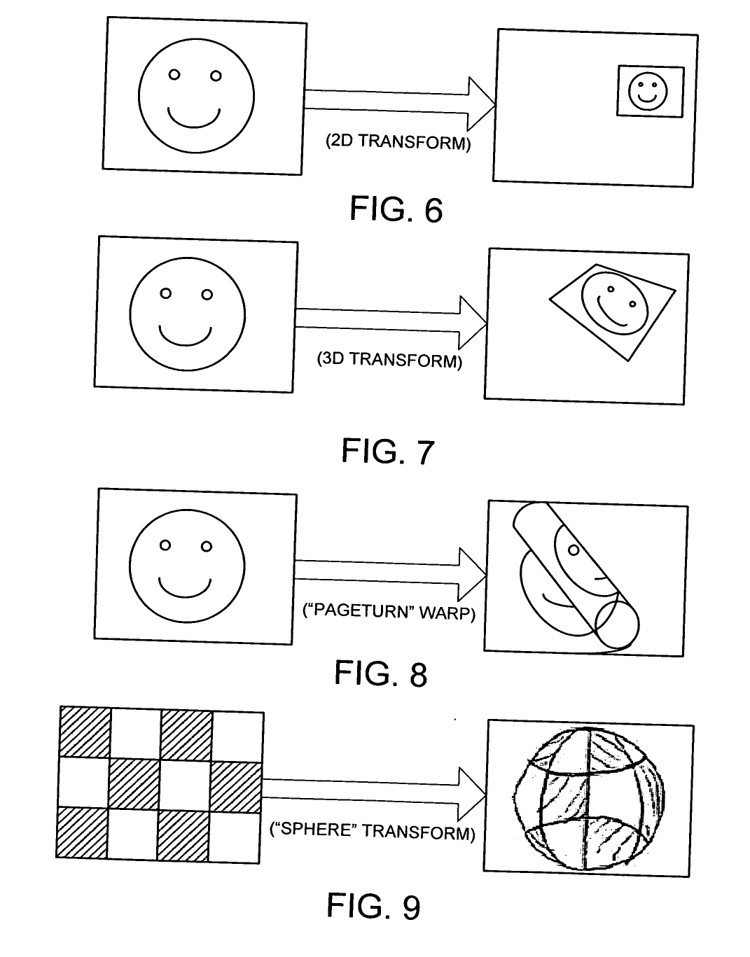

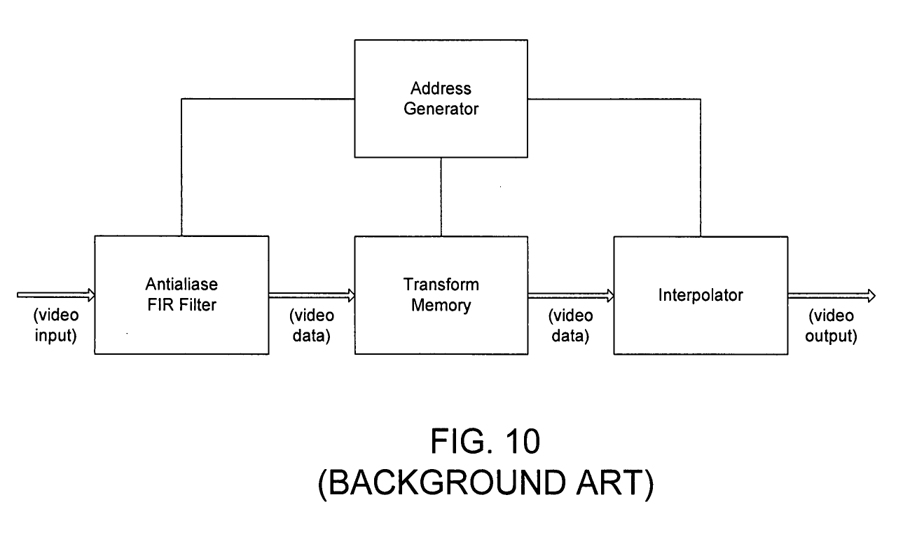

The devices and subsystems of the exemplary embodiments described with respect to FIGS. 1-9 can communicate, for example, over a communications network, and can include any suitable servers, workstations, personal computers (PCs), laptop computers, PDAs, Internet appliances, set top boxes, modems, handheld devices, telephones, cellular telephones, wireless devices, other devices, and the like, capable of performing the processes of the disclosed exemplary embodiments. The devices and subsystems, for example, can communicate with each other using any suitable protocol and can be implemented using a general-purpose computer system, and the like. One or more interface mechanisms can be employed, for example, including Internet access, telecommunications in any suitable form, such as voice, modem, and the like, wireless communications media, and the like. Accordingly, the communications network can include, for example, wireless communications networks, cellular communications networks, satellite communications networks, Public Switched Telephone Networks (PSTNs), Packet Data Networks (PDNs), the Internet, intranets, hybrid communications networks, combinations thereof, and the like.

As noted above, it is to be understood that the exemplary embodiments, for example, as described with respect to FIGS. 1-9, are for exemplary purposes, as many variations of the specific hardware and/or software used to implement the disclosed exemplary embodiments are possible. For example, the functionality of the devices and the subsystems of the exemplary embodiments can be implemented via one or more programmed computer systems or devices. To implement such variations as well as other variations, a single computer system can be programmed to perform the functions of one or more of the devices and subsystems of the exemplary systems. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, for example, to increase the robustness and performance of the exemplary embodiments described with respect to FIGS. 1-9.

The exemplary embodiments described with respect to FIGS. 1-9 can be used to store information relating to various processes described herein. This information can be stored in one or more memories, such as a hard disk, optical disk, magneto-optical disk, RAM, and the like, of the devices and sub-systems of the exemplary embodiments. One or more databases of the devices and subsystems can store the information used to implement the exemplary embodiments. The databases can be organized using data structures, such as records, tables, arrays, fields, graphs, trees, lists, and the like, included in one or more memories, such as the memories listed above.

All or a portion of the exemplary embodiments described with respect to FIGS. 1-9 can be conveniently implemented using one or more general-purpose computer systems, microprocessors, digital signal processors, micro-controllers, and the like, programmed according to the teachings of the disclosed invention. Appropriate software can be readily prepared by programmers of ordinary skill based on the teachings of the disclosed exemplary embodiments. In addition, the exemplary embodiments can be implemented by the preparation of application-specific integrated circuits or by interconnecting an appropriate network of component circuits.

While the present invention have been described in connection with a number of exemplary embodiments and implementations, the present invention is not so limited but rather covers various modifications and equivalent arrangements, which fall within the purview of the appended claims.

1. A method for video transformation, the method comprising:
a. generating arbitrary, non-linear video effects;
b. generating the video effects in real-time or near real-time;
c. providing software algorithms used to generate video transformations corresponding to the video effects;
d. employing a microprocessor to generate an address map corresponding to the video effects;
e. employing an interpolator to read the address map in real-time or near real-time; and
f. manipulating via the interpolator video pixel data in real-time or near real-time to generate a desired output video image corresponding to one of the video effects.

2. The method of claim 1, wherein step (a) includes generating linear video effects.

3. The method of claim 1, wherein step (d) includes employing a Digital Signal Processor (DSP).

4. The method of claim 1, wherein step (d) includes employing multiple microprocessors.

5. The method of claim 1, where step (d) includes storing the address map in a random-access memory (RAM) in which either:
a. the RAM includes an full address map of co-ordinate data; or
b. the RAM includes a partial address map of co-ordinate data and is used as an elastic buffer.

6. The method of claim 1, wherein step (f) includes employing the interpolator for oversampling the video pixel data.

7. The method of claim 1, wherein step (d) includes employing the microprocessor for generating a lighting table, including lighting data for each video pixel, and step (e) includes employing the interpolator for reading the lighting map.

8. The method of claim 1, wherein step (d) includes employing the microprocessor for generating an alpha table, including transparency data for each video pixel, and step (e) includes employing the interpolator for reading the alpha table.

9. The method of claim 1, wherein at least one of steps (d), (e) and (f) includes employing a forward-mapping algorithm.

10. The method of claim 1, wherein at least one of steps (d), (e) and (f) includes employing a reverse-mapping algorithm.

11. The method of claim 1, wherein step (d) includes generating a plurality of address maps.

12. The method of claim 1, wherein step (d) includes running software algorithms from an internal memory of the microprocessor, whereby external memory buses of the microprocessor are freed up for transferring of at least one of transformation co-ordinates, lighting data, and transparency data.

13. The method of claim 12, further comprising selectively loading the software algorithms into the internal memory of the microprocessor at run-time, as needed.

14. The method of claim 1, wherein step (d) includes employing Direct-Memory Access (DMA) to move the address map from an internal memory of the microprocessor to an external Warp Memory Buffer.

15. The method of claim 14, further comprising employing the microprocessor to continue to execute the software algorithms, which generates transformation co-ordinates, simultaneously with the DMA activity.

16. The method of claim 1, wherein the method is implemented with a computer-readable medium including computer-readable instructions embedded therein and configured to cause one or more computer processors to perform the steps recited in claim 1.

17. The method of claim 1, wherein the method is implemented with a computer system having one or more hardware and/or software devices configured to perform the steps recited in claim 1.

18. A system for video transformation, the system comprising:
means for generating arbitrary, non-linear video effects;
means for generating the video effects in real-time or near real-time;
software algorithms configured to generate video transformations corresponding to the video effects;
a microprocessor configured to generate an address map corresponding to the video effects; and
an interpolator configured to read the address map in real-time or near real-time,
wherein the interpolator is further configured to manipulate video pixel data in real-time or near real-time to generate a desired output video image corresponding to one of the video effects.

19. The system of claim 18, further comprising means for generating linear video effects.

20. The system of claim 18, wherein the microprocessor comprises a Digital Signal Processor (DSP).

21. The system of claim 18, further comprising multiple microprocessors configured to generate the address map corresponding to the video effects.

22. The system of claim 18, further comprising a random-access memory (RAM) for storing the address map, wherein the RAM either includes (i) a full address map of co-ordinate data or (ii) a partial address map of co-ordinate data and is used as an elastic buffer.

23. The system of claim 18, wherein the interpolator is configured for oversampling the video pixel data.

24. The system of claim 18, wherein the microprocessor is further configured for generating a lighting table, including lighting data for each video pixel, and the interpolator is further configured for reading the lighting map.

25. The system of claim 18, wherein the microprocessor is further configured for generating an alpha table, including transparency data for each video pixel, and the interpolator is further configured for reading the alpha table.

26. The system of claim 18, wherein at least one of:
the microprocessor generates the address map corresponding to the video effects based on a forward-mapping algorithm;
the interpolator reads the address map in real-time or near real-time based on a forward-mapping algorithm; and
the interpolator manipulates video pixel data in real-time or near real-time to generate the desired output video image corresponding to one of the video effects based on a forward-mapping algorithm.

27. The system of claim 18, wherein at least one of:
the microprocessor generates the address map corresponding to the video effects based on a reverse -mapping algorithm;
the interpolator reads the address map in real-time or near real-time based on a reverse -mapping algorithm; and
the interpolator manipulates video pixel data in real-time or near real-time to generate the desired output video image corresponding to one of the video effects based on a reverse -mapping algorithm.

28. The system of claim 18, wherein the microprocessor is further configured to generate a plurality of address maps.

29. The system of claim 18, wherein the microprocessor is further configured to run software algorithms from an internal memory of the microprocessor, whereby external memory buses of the microprocessor are freed up for transferring of at least one of transformation co-ordinates, lighting data, and transparency data.

30. The system of claim 29, further comprising means for selectively loading the software algorithms into the internal memory of the microprocessor at run-time, as needed.

31. The system of claim 18, wherein the microprocessor is further configured to use Direct-Memory Access (DMA) to move the address map from an internal memory of the microprocessor to an external Warp Memory Buffer.

32. The system of claim 31, wherein the microprocessor is further configured to continue to execute the software algorithms, which generates transformation co-ordinates, simultaneously with the DMA activity.

33. The system of claim 18, wherein the system is implemented with one or more hardware and/or software devices.

34. A device for video transformation, the device comprising:
means for generating arbitrary, non-linear video effects;
means for generating the video effects in real-time or near real-time;
software algorithms configured to generate video transformations corresponding to the video effects;
a microprocessor configured to generate an address map corresponding to the video effects; and
an interpolator configured to read the address map in real-time or near real-time,
wherein the interpolator is further configured to manipulate video pixel data in real-time or near real-time to generate a desired output video image corresponding to one of the video effects.

35. The device of claim 34, further comprising means for generating linear video effects.

36. The device of claim 34, wherein the microprocessor comprises a Digital Signal Processor (DSP).

37. The device of claim 34, further comprising multiple microprocessors configured to generate the address map corresponding to the video effects.

38. The device of claim 34, further comprising a random-access memory (RAM) for storing the address map, wherein the RAM either includes (i) a full address map of co-ordinate data or (ii) a partial address map of co-ordinate data and is used as an elastic buffer.

39. The device of claim 34, wherein the interpolator is configured for oversampling the video pixel data.

40. The device of claim 34, wherein the microprocessor is further configured for generating a lighting table, including lighting data for each video pixel, and the interpolator is further configured for reading the lighting map.

41. The device of claim 34, wherein the microprocessor is further configured for generating an alpha table, including transparency data for each video pixel, and the interpolator is further configured for reading the alpha table.

42. The device of claim 34, wherein at least one of:
the microprocessor generates the address map corresponding to the video effects based on a forward-mapping algorithm;
the interpolator reads the address map in real-time or near real-time based on a forward-mapping algorithm; and
the interpolator manipulates video pixel data in real-time or near real-time to generate the desired output video image corresponding to one of the video effects based on a forward-mapping algorithm.

43. The device of claim 34, wherein at least one of:
the microprocessor generates the address map corresponding to the video effects based on a reverse -mapping algorithm;
the interpolator reads the address map in real-time or near real-time based on a reverse -mapping algorithm; and
the interpolator manipulates video pixel data in real-time or near real-time to generate the desired output video image corresponding to one of the video effects based on a reverse -mapping algorithm.

44. The device of claim 34, wherein the microprocessor is further configured to generate a plurality of address maps.

45. The device of claim 34, wherein the microprocessor is further configured to run software algorithms from an internal memory of the microprocessor, whereby external memory buses of the microprocessor are freed up for transferring of at least one of transformation co-ordinates, lighting data, and transparency data.

46. The device of claim 45, further comprising means for selectively loading the software algorithms into the internal memory of the microprocessor at run-time, as needed.

47. The device of claim 34, wherein the microprocessor is further configured to use Direct-Memory Access (DMA) to move the address map from an internal memory of the microprocessor to an external Warp Memory Buffer.

48. The device of claim 47, wherein the microprocessor is further configured to continue to execute the software algorithms, which generates transformation co-ordinates, simultaneously with the DMA activity.

49. The device of claim 34, wherein the device is implemented with one or more hardware and/or software devices.

50. A computer-readable medium including computer-readable instructions embedded therein for video transformation and configured to cause one or more computer processors to perform the steps of:
a. generating arbitrary, non-linear video effects;
b. generating the video effects in real-time or near real-time;
c. providing software algorithms used to generate video transformations corresponding to the video effects;
d. employing a microprocessor to generate an address map corresponding to the video effects;
e. employing an interpolator to read the address map in real-time or near real-time; and
f. manipulating via the interpolator video pixel data in real-time or near real-time to generate a desired output video image corresponding to one of the video effects.

51. The computer readable medium of claim 50, wherein step (a) includes generating linear video effects.

52. The computer readable medium of claim 50, wherein step (d) includes employing a Digital Signal Processor (DSP).

53. The computer readable medium of claim 50, wherein step (d) includes employing multiple microprocessors.

54. The computer readable medium of claim 50, where step (d) includes storing the address map in a random-access memory (RAM) in which either:
a. the RAM includes an full address map of co-ordinate data; or
b. the RAM includes a partial address map of co-ordinate data and is used as an elastic buffer.

55. The computer readable medium of claim 50, wherein step (f) includes employing the interpolator for oversampling the video pixel data.

56. The computer readable medium of claim 50, wherein step (d) includes employing the microprocessor for generating a lighting table, including lighting data for each video pixel, and step (e) includes employing the interpolator for reading the lighting map.

57. The computer readable medium of claim 50, wherein step (d) includes employing the microprocessor for generating an alpha table, including transparency data for each video pixel, and step (e) includes employing the interpolator for reading the alpha table.

58. The computer readable medium of claim 50, wherein at least one of steps (d), (e) and (f) includes employing a forward-mapping algorithm.

59. The computer readable medium of claim 50, wherein at least one of steps (d), (e) and (f) includes employing a reverse-mapping algorithm.

60. The computer readable medium of claim 50, wherein step (d) includes generating a plurality of address maps.

61. The computer readable medium of claim 50, wherein step (d) includes running software algorithms from an internal memory of the microprocessor, whereby external memory buses of the microprocessor are freed up for transferring of at least one of transformation co-ordinates, lighting data, and transparency data.

62. The computer readable medium of claim 61, further comprising computer-readable instructions configured to cause the one or more computer processors to perform the step of selectively loading the software algorithms into the internal memory of the microprocessor at run-time, as needed.

63. The computer readable medium of claim 50, wherein step (d) includes employing Direct-Memory Access (DMA) to move the address map from an internal memory of the microprocessor to an external Warp Memory Buffer.

64. The computer readable medium of claim 14, further comprising computer-readable instructions configured to cause the one or more computer processors to perform the step of employing the microprocessor to continue to execute the software algorithms, which generates transformation co-ordinates, simultaneously with the DMA activity.
